(19) United States
(12) Patent Application Publication
(10) Pub. No.: US 2003/0105688 A1
(43) Pub. Date: Jun. 5, 2003

(54) Secure digital escrow account transactions system and method

(76) Inventors: Owen H. Brown, Montclair, NJ (US); David Neal Joseph, Little Falls, NJ (US)

Correspondence Address: KATTEN MUCHIN ZAVIS ROSENMAN, 575 MADISON AVENUE, NEW YORK, NY, 10022-2585, US

(21) Appl. No.: 10/010,340

(22) Filed: Dec. 5, 2001

(51) Int. Cl. G06F 17/60

(52) U.S. Cl. 705/31; 705/38; 705/39

(57) ABSTRACT

A secure digital escrow account transaction system and method provides that when a customer pays for retail goods or services by credit card, only the retailer's charges for goods and services are transferred from the customer's bank to the retailer's account. The customer sales tax payments in connection with those purchases however are transferred from the customer's bank into an impound account managed by, in one embodiment, a system linkage. The system linkage could be managed by an outside company which, at the end of each payment period, is responsible for transferring the appropriate amount to the State taxing authority with the appropriate forms and reports required by the State on behalf of the retailer.

### BACKGROUND OF THE INVENTION

Computers facilitate with high speed and accuracy a vast myriad of commercial transactions—including credit card transactions. Merchants, who collect from their customers not only the retail charges for purchased goods and services but, in addition, customer payments for sales taxes on those purchases, are responsible for periodically transmitting to the appropriate taxing authority the accumulated tax payments received during the preceding period, typically monthly or quarterly for State taxing authorities. At the end of each such period, some merchants find that they have spent or otherwise failed to segregate and retain sufficient monies to make the required tax payment to the taxing authority.

There is a need to provide a system and method such that when a customer pays for retail goods or services by credit card, only the merchant's charges for goods and services are transferred from the customer's bank to the merchant's account; but the customer sales tax payments in connection with those purchases are transferred from the customer's bank into an impound account managed, for example, by a system linkage managed by an outside company which, at the end of each payment period, is responsible for transferring the appropriate amount to the State taxing authority, with the appropriate forms and reports required by the State, on behalf of the merchant.

There is a need for a system and method with the functionality for a merchant such that when a customer pays for retail goods or services by credit card, a system linkage is provided which for example, can be managed by an outside company utilizing information and funds to cover the sales taxes for any cash transactions that occurred during the preceding period.

There is a need to provide a means for account transaction management which can be easily interlinked into current proprietary transaction systems and interlinked into current proprietary card networks.

There is a need for a system which can be easily managed such that State sales tax revenue can be easily managed, allocated from credit card account transactions, allowing merchants to easily manage State sales taxation, removing aggravation from merchants and other foreseeable account holders alike.

There is also a need for a system which provides a system linkage to manage escrow payroll accounts earning float as utilized in account transaction management.

### SUMMARY OF THE INVENTION

It is a goal of the present system and method to provide account transaction functionality such that, in one embodiment, the charges for goods/services and not the separate tax portion are transferred to the merchant's account—and the tax amount will be transferred to an escrow account held by the bank who has the transfer relationship with the business owner. This escrow amount would be paid monthly or quarterly, for example to the State where the business account transaction took place.

The robust system and process for account transactions disclosed can easily interlink into networks due to its extensible, object oriented architecture across different credit card processors, service providers/banks process merchant's credit card transaction networks. They are referred to as BANK CARD SERVICES or SERVICE PROVIDERS, which handle transactions between merchants and banks for all cards, but only collect service fees for Visa/MC, Discover, and Diner's Club.

American Express is a separate financial service company. Service providers transfer AMEX charges to AMEX via electronic funds transfers (EFT) and AMEX deducts their own fees before returning net sales to merchants account, which can also link into the disclosed invention.

In one embodiment, the transaction begins with the merchant closing out his, for example, credit card terminal daily and sending the transactions via electronic funds transfer (EFT) to their Service Provider or bank. Once the bank has these funds, the tax would be debited from the gross taxable sales and the net funds would then be sent on via EFT to the merchant's account or other bank card provider, such as American Express—via the disclosed system and network process. The debited tax portion would be credited to the escrow account for future tax payments, for example, from credit cards.

A bank could incorporate the robust object orientated architecture of the process of the present invention into computer software logic it currently has in place to deduct the bank fees charged to the merchant for account transactions. Banks charge whatever is a competitive rate to get a merchants business and usually take their percentage cut at the end of the month based on the merchant's gross sales. American Express takes their percentage at each batch of transactions of recent transactions which can also be managed by the present invention.

A goal of the present invention is to provide a process by which sales tax for account transactions can be directly debited from credit card transactions, escrowed at major financial institutions and paid to the taxing authorities, all with no imposition of burden on the merchant. In fact, the disclosed system and method produces filing Statements and deposits with the government for the merchants via, for example, digital signal for account transactions. This process can be hierarchy specific in that the Service Provider is already creating an electronic transaction which credits the gross amount of a credit card transaction, less the bank provider's fees, to the merchant's bank account at said provider's institution. The sales tax debit would occur prior to both the Service Provider debit and the net credit. The disclosed system and methods robust, customizable architecture provides even decentralized support enablement for banks varying credit/debit hierarchies interlinking due to its object oriented architecture for account transactions.

The system is easily incorporated into present transaction coding by inserting a line of code for exempts, so that no debit and escrow of such sums would occur on transactions, for example.

A tax debiting process for cash transaction can also be offered utilizing another embodiment of the invention. (Cash, for example is defined as physical currency and checks or other foreseeable item of monetary value, for example, information represented as a digital signal). This would enable the merchant to accomplish the same goals as his credit card debits, at no additional burden. In fact, by providing a mechanism by which all of the merchant's transactions are accounted for would facilitate easier and more accurate filings with the respective tax authorities.

This cash transaction tax debiting process may be accomplished in a number of ways. Two methods are detailed here:

At the end of the day after closing out his credit card terminal and sending the transaction via electronic funds transfer or EFT to the Service Provider or bank, the merchant would “swipe” a card which can be called a “cash transaction tax debit” card of CTTD Card, through his credit card terminal. This CTTD card would be provided by the Service Provider to the merchant for the purpose of facilitating debit of the taxable portion of cash sales from his account at the banking institution to the tax escrow account. The total amount of cash transactions would be entered and this information would be sent via the EFT system to the service provider. The information sent focuses not on the sales transaction, but instead on the information transfer. The taxable portion of this cash amount can be calculated and debited from the merchant's account and be credited to the escrow account. In this example process, customary credit card transaction fees are not entailed by focusing on the information transfer resulting in the Service Provider accomplishing an internal debit and credit, enabled by the disclosed process and method. Likewise, the merchant may prefer to utilize the cash transaction debiting process of the disclosed invention once monthly, instead of daily. The information transfer resulting in a debit from the merchant's account and credit to the escrow account would occur in one example just once per month, within a few business days of month end, for example.

Another embodiment of the disclosed system and method which can be incorporated into a modification of credit card terminal technology at the merchant's place of business. The embodiment can foreseeably entail software as well as hardware modification to the credit card terminal. The terminal provider can utilize, in one embodiment, a new function button on the terminal. The function button would allow the merchant to enter the total of his cash transactions, either daily or monthly or other selectable period, and transmit this information to the Service Provider or bank. As in the previous method, this information transfer would facilitate the debit of the taxable portion of cash receipts from the merchant's account and the credit of such amount to the escrow account.

To accomplish the functionality of cash reporting using the existing system architecture, that being the existing merchant hardware, and service provider/bank software, the cash reporting for account transactions could be done from the merchant directly on a daily basis for example, when the merchant closes out their credit card transactions for that day. It would be to the banks advantage to have the merchants report daily when they close their batch or credit card sales, as this would increase the bank float to collecting 100% of the sales tax on gross sales for the impound/escrow account transactions.

In one embodiment, to accomplish the cash sales transaction report for account transactions (CSTR) the merchant would process what is called a forced entry from the merchant's terminal. Merchants would be provided with a password or PIN to make the forced entry of the CSTR. This forced entry would allow merchants to enter their cash sales total manually into their terminal and send the CSTR to the service provided/bank as part of the batch being closed out. Only the CSTR amount would be communicated to the service provider/bank, with the cash remaining with the merchant. Once the bank has the amount of CSTR for the batch, the service provider/bank would debit the appropriate percentage of sales for the CSTR from the merchants business checking account and deposit the debited sales tax into the merchants business checking account and deposit the debited sales tax into the merchants tax escrow account along with the debited tax from the same batches credit card sales.

Incorporating this system into the overall software and system architectural framework of, for example, a bank's tax debiting system will allow the bank to impound and file 100% of the sales tax collected by the merchant for the account transactions. This makes the tax collecting system 100% foolproof from the State's perspective because the bank holding the escrow account will become the agent filing 100% of the merchant's sales tax and not just the credit card portion of the taxes. This would also eliminate all tax related bookkeeping work on the part of the merchant with regard to reporting their sales tax and additionally it would provide a complete reporting of gross sales, sales tax collected, as well as a report of paid and net sales for a given month or quarter of the year, for example.

Additional embodiments comprise, beyond State sales tax collection for account transactions, any and all allocation of taxes easily customizable in real time, which can be paid or charged at a point of sale. For example, even if the government repealed the State sales tax and replaced it with a VAT (Value Added Text), the disclosed digital transfer of account allocations process is object orientated and modifiable thus customizable for new tax account allocations and different system architectures.

The disclosed invention achieves an escrow of funds via credit card account transactions and can be implemented via a (Very Private Network) VPN as well.

Reiterating, it is an achievement of the disclosed system and method that only the charges for goods/services and not the separate tax portion are transferred to the merchant's account—and the appropriate tax amount is transferred to an escrow account held by the bank who has the transfer relationship with the business owner. This escrow amount would be paid monthly or quarterly, for example to the State where the business transaction took place easily, speedily and accurately.

The disclosed invention can be implemented even across the different systems of credit card processors and the Service providers/banks which process retailers credit card transaction. Such transactions are referred to as BANK CARD SERVICES or SERVICE PROVIDERS, archiving transactions between retailers and banks for all cards, but which only collect service fees for Visa/MC, Discover, Diners Club, for example. American Express is a separate financial service company, for example. Service providers transfer AMEX charges to AMEX via electronic funds transfers and AMEX deducts their own fees before returning net sales to retailers account, and are also easily incorporated into the robust system and method disclosed.

To accomplish this for charged transactions: the account transaction begins with the merchant closing out their terminal daily and sending the transactions via electronic funds transfer or EFT to their service provider or bank. Once the bank has these funds, the tax would be debited by the disclosed system and method from the gross taxable sales and the net funds would then be sent on via EFT to the merchants account or other bank card provider, such as American Express.

The disclosed robust system or hardware and method can allow a bank to incorporate escrow account functionality and still interlink into the exact computer software or hardware logic it currently has in place to deduct the bank fees charged to the merchant. Banks charge whatever is a competitive rate to get a merchants business and usually take their percentage cut at the end of the month based on the merchants gross sales. American Express takes their percentage at each batch of transactions. Either process is manageable by the robust system's customizable account transaction allocation.

The impound account would be managed by the service provider/bank in one embodiment, implementing the robust system and method. An outside company could easily handle the impound account utilizing the disclosed system and method as well, offering the disclosed system and method as a web-based services, for example.

The System could be hard-wired yet to prevent the necessity of additional hardware requirements at either the merchant level or at the service provider or bank, the account transaction provides only EFT involvement and interlinks to the disclosed robust systems object software architecture.

For example, no unifying standard is needed to be created at the input or merchant level. Data collected from merchants is unified at the service provider/bank level and taxes are debited in a unified manner, in one example, daily, and impounded in escrow until filed with the State—easily via the disclosed system and method's robust functionality.

EFT systems are well known architecture. The software logic for deducting a certain percent of gross sales is also known as banks utilize it to take their fees. A system for filing tax money with the State is also known since banks regularly make tax payments for corporate clients Yet none of the systems offer the disclosed process of customizable, escrow account allocations as well as the robust functionality of the present system and method.

The EFT system provides security as banks regularly use EFT to pay taxes and move money between accounts.

At the merchant level, it does not matter what kind of initiative is used, be it known MAC, NYCE, or check debit card, as all transactions go through a service provider/bank.

For example, at one possible input level, the merchant digitally signals to the network securely, and at low cost. For example, there are 3 or 4 companies making terminals for use on the merchant level, foreseeably including HYPERCOM, TRANS330, NCR and a few others. However, this is unimportant since no part of the tax debit transaction takes place at the merchant level, it only takes place at a service provider/bank level. One excellent aspect of one embodiment of the disclosed system and method is that the transactions will only take place at one level of the transaction, the service provider/bank level.

It is a goal of the invention to manage for these accounts: for example VISUALLY track the gathering of float via a web enabled checkup to see the status of the account with secure routing with digital signals, for example, as agents doing the reporting across the internet. The disclosed system and method provides a secure web based account available to the merchant that enables the merchant to check the status of their account with the escrow agent. A web based account is enabled to allow the service provider/bank to communicate with the merchant for the retail cash transactions. A web based communication system for any merchant contemplating using this system is provided.

The disclosed system and method recognizes the jurisdictional tax base and computes based on purchases locally, for example.

The method and system can be implemented preferably on the State-by-State level or across the country if required. Service Providers/banks have the ability to adjust the rates they charge for their own fees. Changing the tax rates from State to State is not an issue since the disclosed system and method can easily be customized on a State by State basis in real time.

Since the system incorporate EFTs, encryption for such transactions is well known.

The system and method can be customized to address any tax collection that involves tax liens and levies used by the State and Federal Government to collect back taxes from businesses. For example, many small and large businesses fall behind on taxes for any number of reasons and paying back taxes becomes very difficult and expensive for merchants because of penalties and interest and because businesses rarely have large chunks of excess funds to pay back taxes. The collection of back taxes by State and Federal Governments is also a difficult and expensive job because it involves manpower.

The disclosed robust system and method can be utilized by a State or Federal Government to levy on a business for back taxes. For example, suppose a business owes back sales tax to the State. The State sales tax is 6% but the State would levy the account 16% each month and collect an additional 10% towards back taxes until the debt was paid. The service provider/bank would act as the collection agent for the State or Federal government. The leveraging of the disclosed system and method for collecting is automatic. The disclosed invention cuts the State's man hours spent on collection and allows the merchants to continue operating without harming their business. The system and method could also be used by collection companies that win judgments against businesses to automate account transaction management interlinking to the disclosed system and process.

The disclosed system and method is utilizable in e-commerce. Eventually sales tax will be charged on all e-commerce sales, analogous to current catalog sales. Sales tax will be collected in the State in which a sale takes place, analogous to catalog sales today. As the majority of e-commerce sales and catalog sales are credit card transactions, this system provides an excellent functional service for this type of business and market.

Another embodiment of the disclosed system and method is to provide a service to small businesses as a forced savings plan. Many small businesses are S corporations with profits flowing through to the officers as income. To boost this income a service provider/bank could offer an additional debit to be moved into a savings account for the corporation. Many small businesses lack the discipline to save small amounts of money over time, a proven method of saving money. If the service provider/bank offered the disclosed service to deduct an allocatable % from each transaction and funnel it into a savings account digitally for the businesses, a whole new avenue of income is provided for the bank by the disclosed robust system and method's functionality.

### BRIEF DESCRIPTION OF THE DRAWINGS

The Secure Digital Escrow Account Transaction System and Method will be better understood by the following description taken in conjunction with the following figures:

FIG. 1 shows credit card transaction authorization flow with Tax Impound Escrow Account interlink;

FIG. 2 describes one embodiment of the Escrow 1 impound account process system and method;

FIG. 3 shows proprietary card network interlink to escrow account functionality;

FIG. 4 shows another embodiment of the Proprietary Card Network with escrow account functionality;

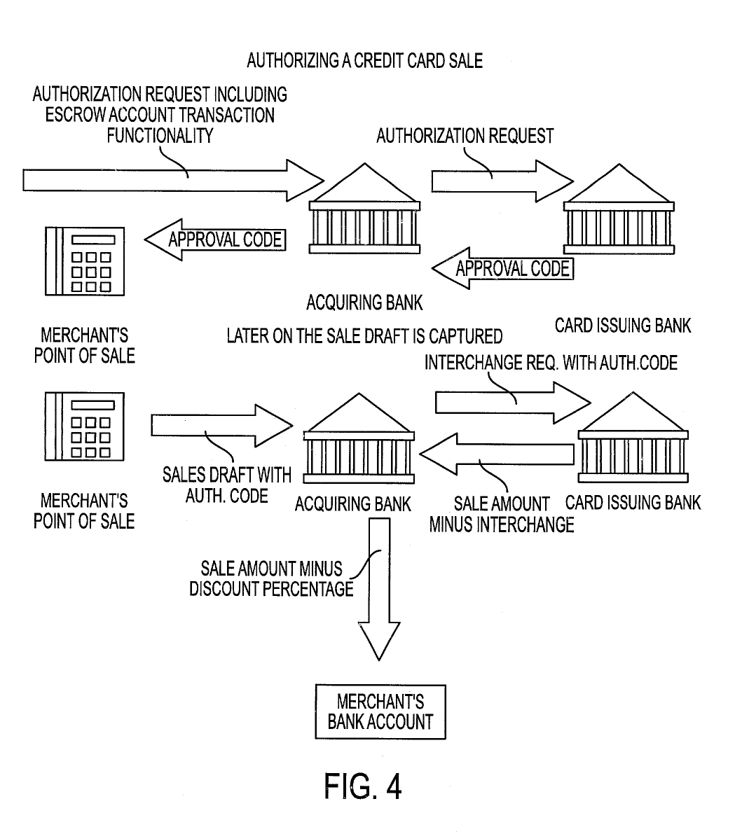

FIG. 5 shows Transaction Processing Incorporating Escrow Account Functionality; AND

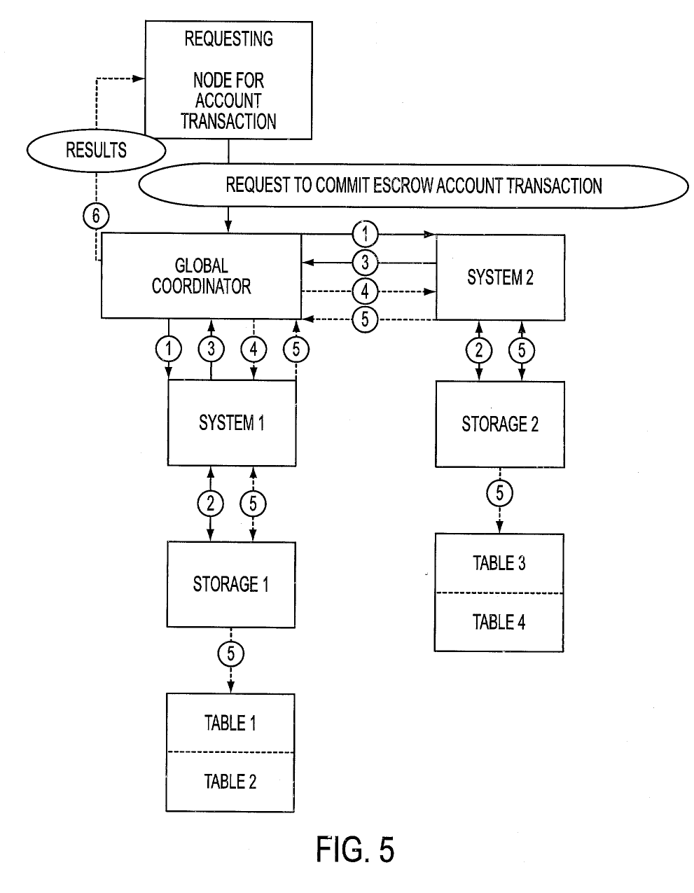

FIG. 6 shows an Internet Content Exchange Package incorporating Escrow Account transaction data.

### DETAILED DESCRIPTION OF THE PREFERRED AND ALTERNATE EMBODIMENTS

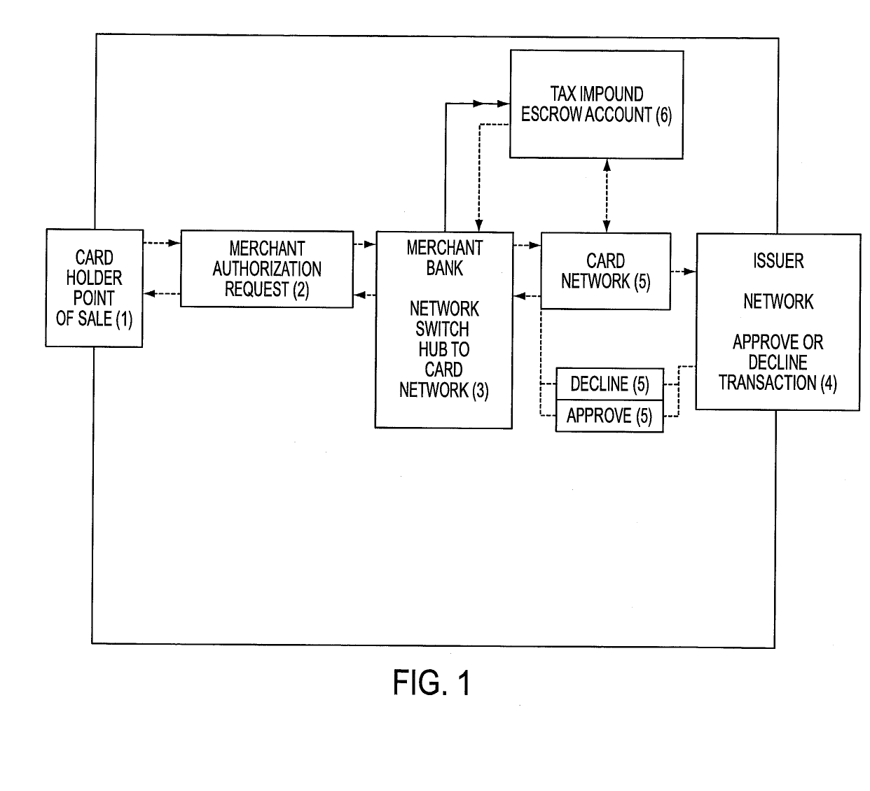

Credit card authorization flow is depicted in FIG. 1.

1. The cardholder presents the proprietary network such as Visa card (card or debit) at the credit or debit point of sale, for example.

2. The merchant uses an electronic terminal or the telephone for example, to request an authorization from the merchant bank, and the request signals forth.

3. The merchant bank creates a proprietary network integrated payment authorization and request message that includes details about the account and the transaction including escrow account transaction signals. In one embodiment, the merchant banks proprietary network integrated payment authorization and request message interlinks to the tax impound escrow account system and method. The message is then switched, for example, through VisaNet, or other proprietary network to the card issuer.

4. The issuer network reviews the request and makes a decision to approve or decline it, and can also interlink to six (6) the tax impound escrow account allocating to the escrow account.

5. The issuer's response is sent back through VisaNet, or other proprietary network to the merchant in a matter of seconds. The response can also include information to decline, approve, and push escrow account allocation to an escrow account via the disclosed system and method.

It is also foreseeable that in some cases, when an issuer is unavailable for authorization, a proprietary network will authorize the escrow account transaction as a part of a stand-in processing service. This is done to further enhance payment system efficiency.

The disclosed escrow system and method could be utilized by Independent Sales Organizations or ISOs. Independent sales organizations play a role in many business fields. In the credit card industry, ISOs act as a third party between the merchant and the acquiring bank. Many businesses are unable to obtain merchant status through an acquiring bank because the bank views them as too large a risk, and need to go through an ISO to obtain merchant status. ISOs can be interlinked and serviced with the disclosed system and method.

It is foreseeable that as part of Interchange—the known transaction that takes place between the acquiring bank and the credit card-issuing bank, an allocation can be made for escrowing by the disclosed system. Interchange is a fee the acquiring bank pays to the credit card-issuing bank in order to process a credit card transaction involving a card holder's account. This fee is regulated by MasterCard and Visa, and is a percentage of the total transaction amount which can also include an escrow account service fee.

Merchant Status is when a business is considered a “merchant” once they have authorization from an acquiring bank, ISO, or other financial institution to accept credit cards and therefore can interlink to the disclosed system and method.

To provide convenient reporting to clients, for example, information on the allocations of the escrow account transactions of the disclosed system and method can be incorporated as part of the “sales draft.”

Sales draft is a known instrument showing an obligation on the cardholder's part to pay money. As part of the disclosed invention the sales draft can also incorporate monthly escrow account status information.

Foreseeably clients of the disclosed invention include First Data, the US's largest processor of credit card transactions, transaction reporting and billing services to financial institutions, oil companies, retailers, Telecheck, and Paymentech as well as others.

The disclosed system and method can interlink into credit card processing services including EMS Nationwide, First of Omaha, First USA Paymentech, First Union—Merchant Sales and Services, Nova Information Systems, Vantage Services, MasterCard, American Express, Discover, Worldwide, Citibank, First USA/BANK ONE, MBNA, Discover, J. P. Morgan Chase, Bank of America, Capital One, Household Bank, Providian, Fleet, and other foreseeable credit card processing services, for example. Due to the disclosed process being customizable and object oriented it can be easily incorporated into existing processing services.

### Impound Account Alternative Embodiment

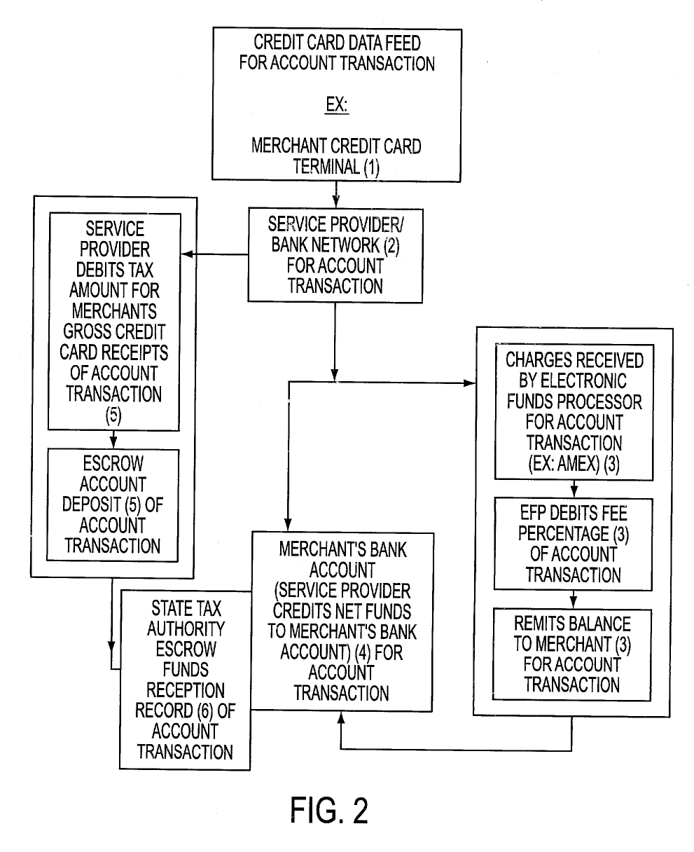

A second embodiment as shown in FIG. 2. demonstrates the IMPOUND ACCOUNT alternative embodiment process flow.

A credit and data feed (1) interlinks with a bank network (2). Charges are received by an electronic funds processor (for ex: AMEX). The EFT debits a fee percentage and remits the balance to a merchant. (3) A digital signal for example is sent to (4) a merchant's bank account such that a service provider credits net funds to the merchant's bank account.

The service provider/bank network (2) can issue account transaction signals to (5) a participating service provider debiting an allocated tax amount for a retailer's gross credit card receipt. An escrow account deposit then issues forth from the service provider across a network.

### Transaction Processing Incorporating Escrow Account Functionality

The disclosed system and method can be easily incorporated into present business operations as follows: Transaction Processing (TP) is the unambiguous and independent execution of a set of operations on data in a relational database, which treats that set of actions as a single event. If any part of the transaction process fails, the entire transaction fails and all participating resources are rolled back to their previous state.

In theory, TP can happen without a relational database, but will be problematic. And a relational database can exist without TP, but would lose one of the benefits of having a relational database: the ability to update multiple tables to reflect the completion of a transaction also foreseeable in another embodiment of the disclosed invention reflecting, for example, current escrow account allocation status.

In one embodiment, the disclosed system and method discloses a system capable of doing TP which passes the ACID test: atomicity, consistency, isolation and durability. Transactions are atomic, meaning they either happen or not. If one account is debited, some other escrow account must be credited.

The TP system of the disclosed system and method is consistent with its own rules which are customizable and can incorporate the present invention. No escrow account transaction can happen if errors are returned as the transaction is processed. For example, if a table that must be updated is on a hard drive server that is inaccessible, the transaction fails.

The system and method disclosed allows that escrow account transactions may be isolated.

Isolating transaction means that other processes never see database tables in an intermediate state. They may get to see what the database looked like before or after the escrow account transaction, but not during. For example, anyone querying a banking account system for open accounts will view all accounts not open at that moment. But if two people try accessing the same account at the same time, only one can securely succeed, providing a measure of security for the disclosed system and method.

Finally, transactions are durable, meaning that once the escrow account transaction is completed and the customer receives notification, that transaction is permanently recorded. Even if the system was hit by lightning after the escrow account transaction was complete, the TP-capable system is able to retrieve it as a backup.

### Two-Phase Commitment TP for the Disclosed Escrow Account System and Method

Known relational databases are sometime defined as systems capable of doing transaction processing by virtue of their ACID-support. The “two-phase commit” (2PC) protocol is a defining characteristic as well as a key mechanism by which the transaction is enabled and is incorporated by the disclosed invention, in one embodiment.

In the first phase of the 2PC, a global coordinator notifies all systems in the transaction that they should prepare to either commit the changes required by the escrow account transaction or roll back their tables to their previous State. The systems involved notify the global coordinator when they are prepared to commit the transaction or that they will not be able to commit the transaction. If a system does not respond, or responds with an error, the global coordinator will abort the transaction and notify systems to roll back the changes.

If all systems are go for the first phase, the coordinator notifies the systems to begin the commit phase by writing all changes and then notifying the coordinator. The transaction is completed only when all systems notify the coordinator that the changes have been committed; if any errors occur at this State, the transaction will be canceled and all participants are required to roll back changes.

Transaction processing is a mature technology, as are the relational database and the transaction monitor. All were introduced in the 1960s and 1970s, as large data processing shops required mechanisms for reliably automating transactions. Over the decades, the cost of supporting TP has dropped to the point at which almost any business can apply it profitably and the robust object oriented disclosed system and method can easily be incorporated into such a system.

Today, the problems of distributing transactions on the Web are similar to the problems of distributing them on systems with disparate data tables spanning multiple tape and disk drives. As a result, extending TP capabilities to the Internet is often as easy as building the interface and business logic for an application on an existing system providing the disclosed robust system and method's escrow accounts functionality, which even provides to e-commerce effective TP mechanisms. The disclosed system and method provides escrow account functionality and can be utilized, verifying the transactions that form the basis for e-commerce accomplished by the disclosed inventions object orientated functionality.

SOAP is the Simple Object Access Protocol which allows applications to pass data and instructions to one another across the disclosed process in one embodiment, based on the WorldWideWeb Consortium's standard (www.23org/TR/SOAP/) and provides a means of assurance and security for all escrow account transactions committed by the disclosed system and method.

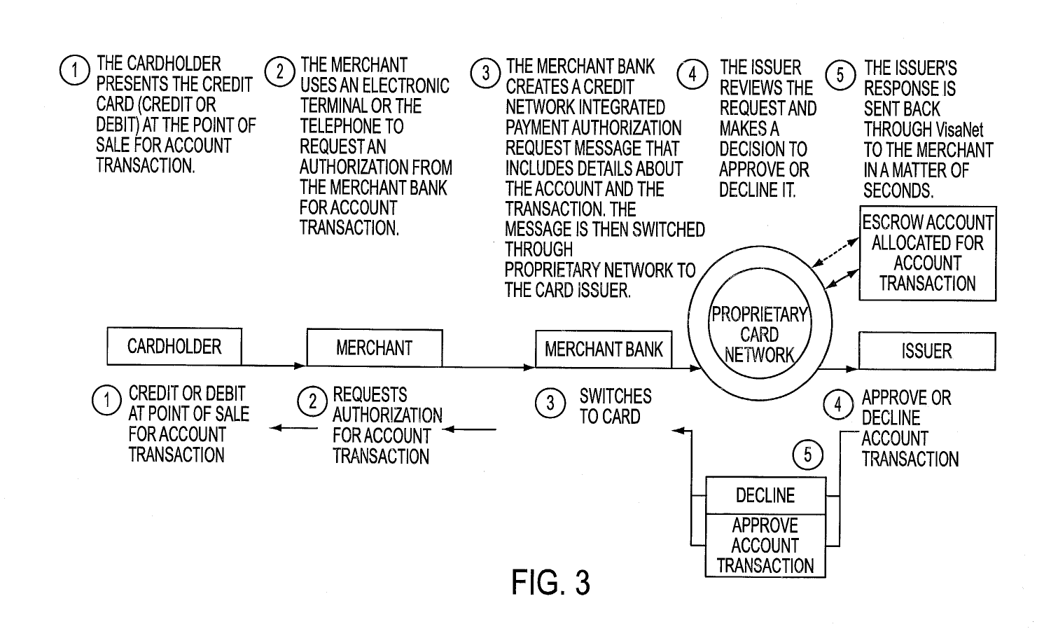

For example: As shown in FIG. 3, Transaction Processing Incorporating Escrow Account Functionality, in one embodiment, the disclosed system and method incorporates relational databases which can be defined as systems capable of doing transactions processing by virtue or their “ACID” support (atomicity, consistency, isolation and durability).

Phase 1

1. Global coordinator notifies systems that tables 1, 2, 3 and 4 need to be updated including escrow account allocation.

2. Systems check everything, including their storage devices, to make sure they are ready to write data to the tables in question, with both the current and new values accessible but no changes made.

3. Systems notify the global coordinator that they are ready to update tables or not. If any system is not able to make the change, it notifies the coordinator, which notifies all systems that the transaction has failed and the transaction therefore aborts.

Phase 2, if Successful

4. Global coordinator, on receiving affirmation from all participating systems about all tables to be updated, notifies all systems that they can update their tables including escrow account allocation and other escrow account information.

5. The systems update their tables and report status to the global coordinator (either success or failure).

6. On receipt of successful completion of the updates to all the tables, the global coordinator can report back to the requesting node that the transaction has been completed.

The modular system and method disclosed can easily be incorporated into present TP operations due to its object oriented architecture, and cross platform standards such as utilizing XML (Extensible Markup Language) and Simple Object Access Protocol (SOAP).

The global coordinators are distinct from the transaction monitor, also commonly known as transaction processing monitor software or the transaction server.

The disclosed system and method can also be incorporated into transaction monitors, middleware programs that mediate between clients and servers, which optimize database performance by acting on behalf of the clients. Rather than have every client open a session with a server, the clients connect to a transaction monitor which queries the server through its own session with merchants for example. This relieves the server from the chore of handling numerous individual sessions.

The disclosed system and method can functionally be incorporated into mainframe systems, and transaction monitors can also be utilized for handling online transaction processing systems providing escrow account services.

For the packets of digital signals of each escrow account it is foreseeable that XML is incorporated into the present system as a functional standard, a way of saying “This next account transaction presents more information.” XML inherently requires, that a description of what the transaction does, how it is to work, or that the escrow account transaction itself conforms to a proprietary standard. Resource Description Format (RDF) will also foreseeably be utilized as a complementary standard to describe functionally the escrow account transaction in terms of a subject, predicate and object.

For example: When XML points to an escrow account transaction in the system as a series of digits, RDF allows for the account transaction to link its computer into the network computer and determine this is the account transaction it should commit. The XML standard allows for easy customization of the disclosed system and method into existing transaction systems, across diverse platforms.

Presently, XML is utilized not just a message transfer protocol for account transaction data, but as a gateway to the programmable Web for the disclosed invention. Fanning account information out to devices and applications that it partners with such as Exchange, SQL Server, and other databases is achieved functionally by XML in the disclosed invention.

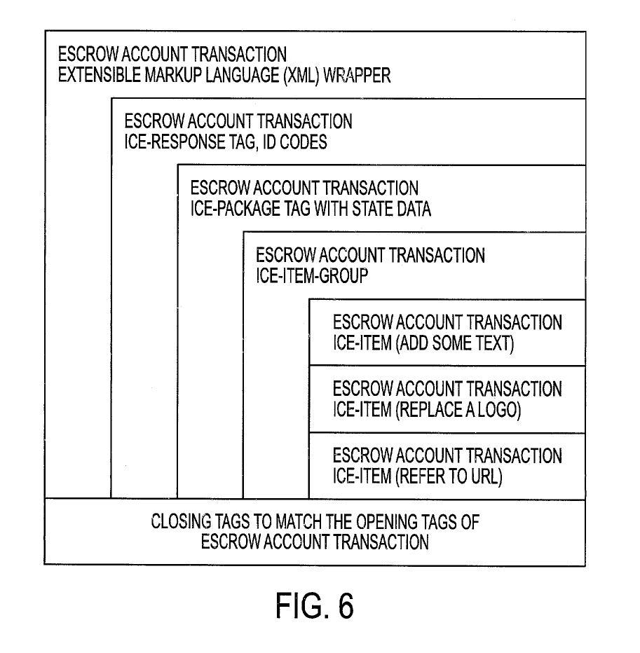

An Internet Content Exchange (ICE) package (or payload, as the complete message is known and called) can contain account escrow information which contains one or more ice-item tags that may contain textual content in XML format, binary data, in base64 encoding, or a URL that refers to a file stored on the Web that should be downloaded and incorporated as part of the payload. An abstraction of the ICE package with Escrow account data is shown in FIG. 6.

Sending data as the right SOAP [Simple Object Access Protocol] message, with addressing permission and transaction data is functionality provided by the disclosed invention, as well.

SOAP provides an interapplication communication mechanism encoding escrow account information within a packaging model (the SOAP envelop), a serialization mechanism (the SOAP encoding rules), and a Remote Procedure Call (RPC) mechanism (the SOAP RPC representation.) A SOAP message is an XML document which can comprise a SOAP Header, SOAP Body, as well as a SOAP Envelope containing account escrow information.

A typical protocol layering of SOAP containing account escrow information can reside above a known Application Protocol (HTTP,SMTP,etc), atop the Transport Protocol (TCP/IP, IPX,SPC, etc.) atop a wire protocol (Ethernet, ATM,etc.)

HTML and the Extensible Markup Language (XML) allow the disclosed process to be offered as a browser-based application utilizing the Internet.

From the HTML subset, XML from the World Wide Web Consortium provides for a data description language, and “self-documenting” accounts. For example, a merchant account can be sent as digital signals incorporating XML tags, and banks or escrow account service provider can assign more descriptive attributes to elements and insert sophisticated entity references increasing organization efficiency and profitability by enabling electronic commerce and enhancing network management capabilities for escrow account functionality and service implementation.

On the electronic commerce front, XML can be leveraged as a standardized framework through which businesses can exchange escrow account data with their partners as well as with customers utilizing the disclosed system and method. In one embodiment for example, Microsoft's BizTalk and Internet Commerce Exchange (ICE) are technology providing robust electronic commerce communications for the disclosed system and method.

XML also helps solve the interoperability problems across an enterprise management implementation incorporating XML as a mechanism for representing management data in a standard manner by the disclosed invention. A workable means of transferring this type of information between management applications and devices is essential to obtaining the Holy Grail of enterprise management interoperability, and is incorporated by the disclosed system and method leveraging networks to escrow accounts easily.

### Payment Security and Secure Escrow Transactions of the Disclosed System and Method

ONLINE PAYMENT PROCESSING is a linchpin of the global e-business economy, handling billions of dollars' worth of transactions each year, keeping the payment pipeline active, ensuring the security of their customers' data.

The disclosed system and method allows a business to work in a secure communications channel, whether account escrow transactions are sent across the Internet or via a dedicated connection, ensuring that data is read by the sender and the intended recipient. Modern encryption technologies protect confidential information from being “sniffed” while in transit extremely well, rendering data illegible (and more or less totally untranslatable) to would be hackers and spies and are incorporated into the disclosed robust system and method.

To facilitate payments over the Internet, the disclosed invention for example can incorporate 128-bit SSL (Secure Sockets Layer) encryption as a minimum security standard between a Web server and a payment gateway. Messages can also be sent using the ISO 8583 standard (the protocol used to exchange data with financial institutions) and can be encrypted with Triple-DES (Data Encryption Standard) and be digitally signed by the vendor when traveling between the payment gateway and financial institution, and are also incorporated into the present invention.

Most quality transaction processing systems already come with encryption features. Digital signatures are another foreseeable technology deployed as part of an enterprise PKI (public key infrastructure) system, sealing all communications “pipes” for escrow account transactions.

An access control policy, is also foreseeable, specifying who has access to what information and can be implemented as part of the implementation of the disclosed system and method. The access control rules are guided by simple common sense: a payment-processing provider should not have access to the merchant's product and pricing information; nor should the merchant have access to the bank's data, or even their clients' credit card information, yet still securely transact escrow account transactions.

In one embodiment, Customers' credit card data is generally never stored on a merchant's site so that customers need not fear that their information will be stolen in the event an attack is launched against the merchant's Web server.

The disclosed invention can also provide, in one embodiment, client authentication, ensuring that customers are who they say they are. For example, many online businesses do not serve customers who use e-mail addresses from free providers, such as Yahoo Mail or Hotmail, because any common thief can open an account with those services. Furthermore, certain types of customer information, such as IP addresses and log-in times, can be logged in a database to refer to if discrepancies in escrow account transactions ever arise. Finally, all credit card numbers can be verified with the issuing bank in real time with the disclosed invention.

More stringent techniques are required for high-value transactions; which can also be serviced by the disclosed invention. Some businesses require at least two members of the purchasing organization to approve multimillion dollar deals. At a minimum, a big-ticket account transaction is governed by stronger authentication methods than a user ID and password. Smart cards, tokens, digital certificates, and biometrics are all useful methods in these cases implementable by the disclosed invention.

Merchant Web sites and payment gateways all run on servers connected to a network, and those servers—along with the applications running on them—can also be secured. In one embodiment, the modular architecture of the disclosed invention allows for periodic audits and security assessments. Checking that system patches are up-to-date, user accounts current, and unnecessary services are removed from all systems are all possible due to the object orientated functionality of the disclosed system and method.

An interwoven blend of complimentary technologies and practices can be incorporated due to the modular, object orientated technology of the disclosed system and method which is easily customizable to incorporate changing standards so that revenue streams and reputations can rely on secure systems, with customers comfortable about doing business with the disclosed system and method achieving escrow account transactions across the network.

It is foreseeable that in protecting online payments, transactions are secured by precautions which can be taken at every point in the payment process and escrow deposit.

For example, for customer systems: client authentication such as passwords, biometrics, and smart cards can help ensure account transactions are with an authorized buyer and valid escrow account.

For merchant web site: web servers can be appropriately hardened against attack and are not used to store payment-related information such as credit card numbers regarding each escrow transaction.

For customer-to-merchant connections: 128-bit SSL connections prevent hackers from sniffing passwords, escrow account numbers, personal information, and credit card numbers from online account transactions of the disclosed invention.

For the payment-processing gateway: all payment-related information is communicated to the buyer's and seller's financial institutions through a payment-processing gateway that validates credit card numbers before the transaction is approved.

Across the financial network: communications between the payment-processing gateway incorporating the escrow account system and method and financial institutions will follow the ISO 8583 standard. Additionally, all communications can be encrypted using 3DES and digitally signed to prevent tampering, ensuring reliable escrow account transactions.

Known electronic bill presentment and payment (i.e. EBPP), long a key component of b-to-c transactions, with b-to-b transactions still largely handled by legacy, batch-oriented methods, such as the ACH (Automated Clearing House) can incorporate the disclosed process and functionality of escrow account services.

For example: The disclosed robust system and method can be incorporated into existing architectures utilizing XML and other Web standards to process billing and payments allowing companies to avoid reinventing the wheel for every trading partner, providing a number of advantages compared with customized legacy methods. In one embodiment EBPP processing can be migrated with all trading partners to the same Web interface, so that businesses can reduce costs, automate workflows using a single standard, and increase the amount of reporting capabilities to better manage the billing and payment cycle. They can also adapt to changing market conditions more quickly, because new suppliers and customers can be integrated much more easily via the Web than via legacy methods linking into the disclosed systems robust object orientated architecture, by going beyond simply handling transactions for e-commerce Web sites by supporting the exchange of XML and other standards-based messages necessary for back-office b-to-b (business to business) escrow transaction processing capable of handling b-to-b EBPP operations,

The disclosed robust system and method can be utilized to implement a EBPP with escrow account allocation solutions that adhere to open standards while supporting the strong security measures to allow b-to-b electronic billing and payment processes to traverse the Internet with an embodiment supporting XML as defined by the World Wide Web Consortium (W3C) as well as strong encryption measures.

### EBPP with Escrow Account Functionality Secured Via PSPs

In managing a corporate b-to-b EBPP strategy in-house, the same disclosed system and method can be utilized and serviced by PSP (payment service provider), out-sourcing EBPP with escrow account allocations doing business with several different trading partners.

In utilizing the disclosed invention, PSPs can use one of three pricing models to derive revenues from the escrow account services and functionality provided. The first approach is for the PSP to charge based on a percentage figure of the overall value of escrow account transactions. A second method is to charge a flat fee for every escrow account transaction regardless of dollar amount. A third approach is for the PSP to charge an amount based upon the volume of escrow account transactions it processes utilized the disclosed system and method.

Secure encryption methods, datacenter, backup and recovery methods are offered to ensure reliability, availability, and accountability in implementing the disclosed system and method by PSPs for account transactions.

The modular system and method of the disclosed invention can be easily incorporated to focus on electronic payments, as well as other Web-based e-commerce account transactions.

For b-to-b EBPP strategy the disclosed system and method can comprise support of both bill presentment and payment supporting both sides of the equation while providing escrow account transaction functionality. With careful integration of the system and method to billing and payment transactions, information can be integrated with known accounting software.

The disclosed system and method can be utilized with batch-oriented, legacy methods of processing b-to-b billing and payments in another embodiment. It is foreseeable though that using the Internet and XML, instead of legacy methods of communication and transactions with multiple trading partners will best achieve a modular, globally supported process easily integrated and customizable.

The object orientated modular architecture of the disclosed process can be incorporated implementing an Internet-based EBPP solution as well as part of a traditional, batch-oriented billing and payment processing of account transactions. Rather than requiring customized interfaces for each trading partner, EBPP enables businesses to reduce costs by standardizing on transmission methods and transaction formatting while servicing an escrow account in one embodiment while keeping security, reliability, and integration in mind.

### Architecture

The disclosed system and method can comprise application servers which drive corporate websites. The disclosed system and method can be incorporated into a company's two-tier client/server model or a three-tier thin-client architecture incorporating a service web front for merchant transactions.

For example Java-based middleware applications running on BEA Systems' WebLogic Java application server, Java-enabled cell phones and PDAs present an opportunity to extend feature-rich enterprise escrow account service applications to mobile clients such as traveling merchants for account transactions.

Enterprises which communicate XML-based Web services architectures, make it easy for developers to extend applications to a variety of client devices to offer the disclosed escrow account system and method.

In one embodiment of the disclosed system, a Java-based middleware architecture, delivers data through a variety of client channels-including, ultimately, wireless devices, foresecably, with account management with HTML, as well as via XML client interfaces.

In one example, J2EE is a framework incorporated for building the disclosed process functionality, using technologies such as servlets (Java applets that run on a server), Enterprise JavaBeans to exchange data and application objects, and Java server pages (JSP) to generate HTML or XML for Web-based client interfaces.

The standards provided by J2EE allow, in one embodiment, the disclosed invention to provide in effect, an operating system for enterprise applications, handling low-level programming issues such as data access, file management and interoperability among systems by utilizing J2EE.

A wide range of middleware based on J2EE—BEA Systems, Bluestone, Borland, IBM and Sun's iPlanet all offer Java-based application servers as well as Microsoft. Net, IBM WebSphere or BEA Systems WebLogic, and are foreseeably incorporated.

The disclosed system and method can be implemented in one embodiment running on for example, Linux or Windows with the following components: MySQL, mySQL JDBC drive, Apache SOAP v2.0, Apache Tomcat, JDK 1.3, Xerces XML Java Library as well as UNIX for account transactions.

In one example, the modularity of the disclosed invention and system can rely on Java to provide a middleware layer providing a good balance between rapid development-thanks to its object-oriented nature and the wide availability of Java components-and the ability to access low-level computing processes allowing easy integration of the disclosed system and method into existing processes for account transactions.

A Microsoft implemented architecture for account transactions is also supported by the disclosed system and method to easily incorporate evolving Web service standards such as SML and Simple Object Access Protocol, as realworld implementations often reflect an a la carte approach aimed at keeping costs low.

The disclosed system and method can be implemented utilizing .Net as Microsoft customers will have to migrate to Visual Studio .Net tools such as C#, Visual J# or Visual Basic .Net as well as the .Net operating system.

Visual Studio.Net (Developer tools such as C# and Visual J#), Windows.Net Server 2002 SQL XML 2.0 MS XML 4.0 tool SOAP 2.0 tool, for example, are tools which can be utilized to implement the disclosed process for account transactions.

Microsoft's free user-authentication service, called Passport can be foreseeably customized to offer the disclosed process for account transactions, in one embodiment.

The Passport formerly known by the code name HailStorm.Net My Services gives users the ability to store a wide range of information including escrow account transaction information, electronic account information and other data such as a personal profile. Users can grant individuals or companies permission to access their information in order to ease or customize their Web experience to offer the disclosed process implementing Microsoft.Net services through standard protocols and formats such as HTTP, XML and Simple Object Access Protocol (SOAP). SOAP is the Simple Object Access Protocol allows account transaction applications functionality to pass data and instructions to one another across the disclosed process in one embodiment, based on the WorldWideWeb consortium's standard (www.23org/TR/SOAP/.)

Foreseeably, corporations can also elect to host their own authentication systems and establish a trust relationship with Microsoft's Passport system through Kerberos security standards for account transactions. The connection could be made in a federated fashion, in much the same way that banks now link automated teller machine networks, to the Internet trust network, a foreseeable embodiment of the disclosed novel system and method.

Due to the object oriented robust architecture, the system can be implemented into even a completely decentralized system.

The disclosed process can be implemented with Microsoft's server operating system, Windows.Net Server, enabling Passport federation through Active Directory, using Kerberos security, enabling the disclosed process as a business-to-business Web service needing escrow account functionality.

### Web Services

The disclosed solution being a process can be incorporated with middleware products which provides a common messaging environment across desktop clients desiring escrow account functionality.

The disclosed system can be implemented as a Web service, an application using a universal language to send data and instructions to one another, with no translation required across an Internet as connection in one embodiment utilizing XML.

To provide financial account aggregation services to banks and portals, the service can scrape checking and credit card balances off Web pages by logging and simulating the merchant, or it asks each financial institution individually to relay data, in one embodiment.

Instead of numerous requests for data feeds, each bank could set up the disclosed process as a Web service that provides account balances and escrow transactions.

The address of the Web service is published in a directory—the Universal Description, Discovery and Integration directory—which locates each Web service on the Internetwork. (UDDI) Universal Description, Discovery and Integration is also utilized to allow the process to be offered as a Web service to be listed in a directory of Webservices easily found (www.uddi.org.) can also be utilized by the disclosed invention.

Each bank can write in a description of what its Web service would require as input and what information would be given out in return. For example, the bank would want the customer's account number and personal identification number, escrow account information as well as password, and confirmation that payment for the information had been sent. The format for this description would be defined in the XML-based Web Services Description Language. WSDL Web Services Description Language is utilized in one embodiment to provide the process as a Web service, allowing the disclosed escrow account functionality to be described and be used by other applications (www.w3org/TR/wsdl.)

On the front end, the bank would need to limit access to customer account balances to a select list of approved intermediaries. Limiting access can foreseeably require authentication through passwords, public keys or other earlier disclosed mechanisms. Finally, it can confirm that payment for the escrow service had arrived and push a receipt across the network.

Authentication methods, access restriction, prioritization and non-repudiation are all incorporated into the disclosed process and system.

For example, if a bank wanted to build the disclosed system from scratch, Microsoft BizTalk Server could be utilized, to handle logging, authentication and routing. On the back end, the disclosed Web service can interlink to each customer's balance. The process, in one embodiment, can “scrape” the data off a “green screen” or other interface, with the bank itself doing the scraping and controlling the process to service escrow accounts.

A sample BizTalk message would go for example as follows:

a receiving application of the escrow account data would know this a BizTalk protocol because of the wrapper (which indicates the specific schema used to formulate the document). The receiving application knows the format of the specific data because the <MsgType> tag points to the schema an account escrow application is using internally to format the data. For example:

<BizTalk xmlns=”urn:schemas-biztalk-org:BizTalk/biztalk-0.81.xml”>

<Route>

Account escrow routing tags here

</Route>

<Body>

<MsgType xmlns=”um:applicationnamespace-here”>

Escrow Account document here

</MsgType>

</Body>

</BizTalk>

Other foreseeable implementations include Document Type Definitions (DTD) schema for a basic escrow account document description instead of the robust XML Schema document.

Another alternative would be to turn existing legacy application into Web services by adding code or recompiling it to run on, for example, Microsoft's emerging .Net platform and implementing the disclosed system and method offering escrow account functionality.

While the preferred embodiment of the invention has been shown in detail, modification and adaptations may be made thereto, without departing from the spirit and scope of the invention as delineated in the following claims:

What is claimed is:

1. A method of gathering the collection of an impound tax account transaction system by a network means, said method comprising the steps of:
interlinking a credit card account transaction data feed input comprising at least one of:
a merchant credit card terminal;
a networked account transaction application; and
a transaction application;
relaying said account transaction signals to service provider network;
allocating said account transaction based on impound tax system criteria comprising debiting said account transaction for at least one of:
a tax amount from merchants gross credit card receipts;
a state tax lien;
a value added tax; and
a system customizable amount;
escrowing said account transaction deposit;
networking said account transaction allocation deposit;
securely signaling a web based transaction application record of said account transaction escrow fund reception to at least one of:
a tax authority; and
a merchant credit card terminal;
said service provider network signaling said account transaction charges received by electronic funds processor; and
said electronic funds processor debiting customizable selected fee percentage of said account transaction;
remitting said account transaction balance networked to interlinking credit card account transaction data feed comprising:
a merchant credit card terminal,
a networked account transaction application,
a transaction node;
interlinking to said account transaction comprising a merchant's bank account; and
allocating from said account transaction allocation based on customizable system criteria comprising allocation of net funds to said merchant account.

2. A method of gathering the collection of an impound tax account transaction by a network, said method comprising the steps of:
interlinking a plurality of merchant point of sale terminal network functionality links of a plurality of merchants at different link locales, each terminal network functionality link including credit/debit card functionality and cash payment functionality for enabling the receipt of payment of said account transaction;
gathering credit/debit card payment and information from the sale transactions of said merchant terminal network functionality of at least one of a plurality of said merchants for said account transactions;
calculating tax impound information for each individual payment of said account transaction at a selectable or a dedicated transaction node;
accumulating the customizable amount comprising a lien percentage of said account transactions for each terminal network link during a customizable time interval;
storing accumulated total of tax for said account transaction impound information for each interlinked terminal network functionality of said account transaction;
relaying to merchant computer functionality from at least one of:
said terminal network functionality;
centralized network tax impound transaction server; and
decentralized network tax impound transaction server a message for said account transaction comprising:
the accumulated totals of tax information for at least one of said terminal network functionality for said account transaction; and
the identification of the merchant terminal network functionality;
relaying said message of said account transaction;
generating an authorization code to instruct the merchant bank to impound the taxes of said account transaction;
directing the tax payment based on customizable impound system criteria allocation of merchant criteria for said account transaction; and
confirming payment via network said account transaction status via visualization functionality.

3. A system for gathering the collection of an impound account transaction tax system by a network, said system comprising:
an interlink linking credit card account transaction data feed input from:
a retail credit card terminal;
web based internetworked account transaction application; on
other account transaction application;
a relay relaying account transaction signals to service provider bank network; means for allocating account transaction based on impound tax system criteria, said criteria comprising debit functionality of said account transaction for at least one of:
a tax amount from retailers gross credit card receipts of said account transaction;
a state tax lien for said account transaction;
a value added tax for said account transaction; and
a system customizable amount for said account transaction;
escrow for said account transaction deposit;
deposit functionality for internetworking said account transaction allocation deposit;
secure signal functionality signaling a web based transaction application record of said account transaction escrow fund reception;
to at least one of:
a tax authority;
a retail credit card terminal; and
a web based transaction application;
said service provider bank network signaling said account transaction charges received by electronic funds processor; and
debit functionality for said electronic funds processor debiting customizable selected fee percentage of said account transaction;
remittance functionality for remitting said account transaction balance networked to interlinking credit card data feed for account transaction, said data feed received from at least one of:
retail credit card terminal;
a web based networked for said account transaction application; and
other transaction application node for said account transaction;
interlink for interlinking to said account transaction comprising a merchant's bank account; and
allocation functionality for allocating from said account transaction based on customizable system criteria comprising an allocation of net funds of said account transaction to retailer account.

4. A system for gathering the collection of an impound tax of an account transaction by a network, said system comprising:
interlink functionality for interlinking a plurality of merchant point of sale terminal;
network links of a plurality of merchants at different link nodes each of said terminal network links including credit/debit card functionality and cash payment functionality for enabling the receipt of payment of account transactions at least one;
collection functionality for gathering credit/debit card payment and information from the sale transactions with the merchant terminal network links by a group of merchants for said account transaction;
calculation functionality for calculating tax impound information for each individual payment transaction at a selectable or a dedicated transaction for said account transaction;
accumulation functionality for accumulating for said account transaction selected percentage for said account transaction comprising lien percentage of said account transaction for each terminal link during a customizable time interval;
storage functionality for storing accumulated total of tax impound information for each of said interlinked terminal for said account transaction;
relay functionality for relaying a message of said account transaction comprising the accumulated totals of tax information of said account transaction for a given terminal, identification of the merchant terminal of said account transaction and functionality for relaying the message, said message being relayed to merchant computer means from at least one of:
said terminal networks;
centralized network tax impound transaction server; and
decentralized network tax impound transaction server;
authorization functionality for generating an authorization code to instruct the merchant bank to impound the taxes of said account transaction;
functionality for directing the tax payment based on selected impound system criteria allocation of merchant criteria for said account transaction; and
payment confirmation functionality for confirming payment to network for said account transaction via at least a visualization application.

5. The system of claim 3, wherein said account transaction functionality comprises a customizable account allocation including at least one of:
gross funds of said account transaction;
net funds comprising gross funds less tax amount due to customizable account transaction allocation percentage said net funds comprising
an amount based on criteria established by a pertinent taxing authority;
any applicable service provider fee;

6. The system of claim 5, further providing confirmation of final account transaction allocation status.

7. The system of claim 3 wherein the system uses object orientated programming construction of systems functionality.

8. The system of claim 3, wherein communication of digital signals in said systems employs machine code, Java, C, C#, C++, XML, markup language, PERL, CORBA messages ISO 8583 data, SSL data, DES signals, digital signals, PKI, certificates, biometrics data, SOAP messages, data objects, Java Beans, SQL data, SML data, DTD data, Kerberos data, UDDI data, assembly language, or machine language.
